(19) United States
(12) Patent Application Publication
(10) Pub. No.: US 2014/0097158 A1
(43) Pub. Date: Apr. 10, 2014

(54) MIG/MAG WELDING OF STAINLESS STEELS WITH ROTARY ARC AND AR/HE/CO2 GASEOUS MIXTURE

(71) Applicants: Laurent Biskup, Serifontaine (FR); Jean-Pierre Planckaert, Monneville (FR)

(72) Inventors: Laurent Biskup, Serifontaine (FR); Jean-Pierre Planckaert, Monneville (FR)

(73) Assignee: L'Air Liquide Société Anonyme pour I'Etude et I'Exploitation des Procédés Georges Claude, Paris (FR)

(21) Appl. No.: 14/116,797

(22) PCT Filed: Apr. 20, 2012
(86) PCT No.: PCT/FR2012/050865

§ 371 Date: Nov. 11, 2013

(30) Foreign Application Priority Data
May 11, 2011 (FR) 1154051

(51) Int. Cl. B23K 9/16; B23K 9/173

(52) U.S. Cl. CPC B23K 9/164; B23K 9/173
USPC 219/74

(57) ABSTRACT

The invention concerns a MIG/MAG-type electric arc welding method that uses a consumable filler wire and gas protection formed by a ternary gaseous mixture comprising 19 to 21% helium, 0.8 to 1.2% CO2 and argon for the remainder (% of volume), in order to weld one or more pieces of stainless steel. According to the invention, the arc is rotary, the consumable filler wire is melted by the arc such as to transfer metal by means of a rotating liquid flow, and the welded parts comprise overlapping ends.

### CROSS REFERENCE TO RELATED APPLICATIONS

This application is a 371 of International PCT Application PCT/FR2012/050865, filed Apr. 20, 2012, which claims priority to French Application No. 1154051, filed May 11, 2011, the entire contents of which are incorporated herein by reference.

### BACKGROUND

The invention relates to an electric arc welding process of MIG/MAG type with use of a consumable filler wire and gas shielding formed of a ternary gas mixture formed of argon, helium and carbon dioxide (CO₂) to weld one or more parts made of stainless steel, in particular parts having ends which overlap each other.

Lap joints join together two sheets or sections, the ends of which overlap each other or, in other words, rest on each other, as is the case in particular in “conventional lap” joints or joints in a configuration of joggled lap type.

The joints of metal parts in a configuration of joggled lap type, commonly known as joggled lap joints, are found in particular in the constituent components of pressure vessels of the following types: hot water tanks, extinguishers, compressors, refrigeration devices, LPG gas cylinders, and the like.

As illustrated in FIG. 3, such a joint generally comprises two parts having hollow cylindrical ends, one of which is inserted into the other so that the internal surface of one of the parts will overlap, over several millimeters, the external surface of the other part at their circular ends.

Standard EN 13445-4:2002 precisely defines the manufacturing tolerances relating to the alignment of neutral fibers, the alignment of surfaces, deviations from circularity, deviations from straightness, profile irregularities and local thinning of such joints.

Schematically, the weld obtained on this type of lap joint, in particular on joggled lap joints, that is to say with edges which partially overlap or cover each other, as illustrated in FIG. 3, has to exhibit a fairly wide profile in order to thoroughly cover the outside of the joint and have a sufficient penetration to melt the lower shoulder of the upper edge.

It should also be remembered that, as a function of the welding process, after each pass, the slag which is formed during the preceding pass has to be removed, the surface cleaned and the surface defects removed in order to obtain the desired weld quality.

The document EP-A-2 078 580 has provided for the welding of joggled lap joints by a MIG/MAG welding process with rotary arc and by using a gas mixture consisting of 8-12% of helium, of 2.5 to 3.5% of oxygen and of argon for the remainder (% by volume).

However, this process exhibits the disadvantages of resulting in an insufficient arc constriction, which results in welds having a penetration profile which is not always that desired.

Furthermore, the mixture provided by EP-A-2 078 580 makes it necessary to employ a slightly higher voltage in order to be 100% free of extremely brief but intense short circuits.

In point of fact, to weld stainless steel, in particular parts having ends which overlap each other, presents a certain number of specific problems.

Thus, with a gas comprising from 10 to 20% He, from 2 to 3% O₂ and argon for the remainder, the transition region between the spray transfer and the rotating liquid vein transfer is broader. This is because it has been shown that, at the same energy level, the molten portion of the wire is longer made of stainless steel than made of carbon steel. Consequently, it is necessary to go higher in voltage in order to prevent the brief and intense short circuits which are reflected, in the final product, by significant spatter.

Furthermore, with a gas comprising 10 to 20% He, 3% O₂ and argon for the remainder, the surface appearance of the beads obtained on the stainless steel exhibits an oxidation which is too high to be compatible with an industrial use.

Finally, the high voltage levels required in order to achieve a rotating liquid vein regime devoid of short circuits cause segments of molten wire to detach away from the weld pool. The part thus welded then exhibits adherent spatter which is, here again, incompatible with the desired quality.

The document U.S. Pat. No. 4,749,841 has provided a process for welding parts made of stainless steel of MIG/MAG type using a shielding gas consisting of 16 to 25% of helium, of 1 to 4% of CO₂ and of argon for the remainder.

However, this process uses a metal transfer regime of pulsed type which is not suitable for the welding of parts having ends which overlap each other, in particular due to the morphology of the bead, which is excessively rounded, and the penetration profiles obtained.

Starting from here, the problem which is posed is that of providing a process for the effective arc welding of stainless steel which makes it possible to obtain good penetration and good welding quality, in particular good welding bead morphology, and no spatter or spatter which is reduced as much as possible during welding, in particular joints made of stainless steel which overlap, in particular those of joggled lap type or of conventional lap type, this being achieved at a low energy level.

### SUMMARY

The solution of the invention is then a process for electric arc welding of MIG/MAG type with use of a consumable filler wire and gas shielding formed of a ternary gas mixture consisting of 19 to 21% of helium, of 0.8 to 1.2% of CO₂ and of argon for the remainder (% by volume) in order to weld one or more parts made of stainless steel, characterized in that the arc is a rotating arc, the consumable filler wire is melted by the arc, so as to obtain transfer of metal by a rotating liquid vein, and the welded parts comprise ends which overlap each other, in particular in conventional lap or joggled lap fashion.

More specifically, the vein of liquid metal, i.e. molten metal, is driven with a rotating movement. The vein of liquid metal is formed by melting the consumable filler wire within the electric arc.

As the case may be, the welding process of the invention can comprise one or more of the following characteristics (% by volume):
the gas mixture comprises at least 19.5% of helium, preferably at least 19.8% of helium, more preferably at least 19.9% of helium,
the gas mixture comprises at most 20.5% of helium, preferably at most 20.3% of helium, advantageously at most 20.1% of helium,
the gas mixture comprises at least 0.9% of CO₂, preferably at least 0.95% of CO₂,
the gas mixture comprises at most 1.10% of CO₂, preferably at most 1.05% of CO₂,
the gas mixture comprises from 19.95 to 20.05% of helium, from 0.98 to 1.02% of CO₂ and argon for the remainder,
the gas mixture is composed of 20% of helium, of 1% of CO₂ and of 79% of argon,
the gas mixture is prepackaged in a gas tank, in particular in gas cylinders,
the gas mixture is produced in situ using a gas mixer which serves to mix the argon, the helium and the oxygen in the desired proportions by volume,
the welded parts comprise cylindrical ends which overlap each other,
the welded parts are constituent components of a pressure vessel of the following types: hot water tanks, extinguishers, compressors, refrigeration devices or LPG gas cylinders,
the welding voltage is between 29.5 V and 35 V,
the welding intensity is between 245 A and 300 A,
the welding wire is of ER 308L Si type,
the wire feed rate (Vwire) is at most 30 m/min, typically between 16 m/min and 20 m/min,
the welding rate is at most 5 m/min, typically between 0.8 m/min and 2 m/min.

### BRIEF DESCRIPTION OF THE DRAWINGS

The present invention will be explained in more detail in the following description, made with reference to the appended figures. For a further understanding of the nature and objects for the present invention, reference should be made to the following detailed description, taken in conjunction with the accompanying drawings, in which like elements are given the same or analogous reference numbers and wherein:

FIG. 1 gives a diagrammatic representation of the influence of the type of transfer on the morphology of the bead,

FIG. 2 gives a diagrammatic representation of a rotating liquid vein, and

FIG. 3 gives a diagrammatic representation of a joggled lap joint.

### DESCRIPTION OF PREFERRED EMBODIMENTS

Generally, in MIG-MAG arc welding, there are three main or conventional transfer regimes, namely:
short-circuit. This regime is obtained for low arc energies, typically from 50 to 200 A and from 15 to 20 V. A drop of molten metal forms at the end of the filler wire and gradually enlarges until it comes into contact with the pool of molten metal, which causes a short circuit. The current then increases rapidly, making a pinching appear which facilitates the detachment of the drop, then the arc reignites. This phenomenon is repeated at frequencies of 50 to 200 Hz approximately. This regime is said to be “cold” and has a short arc. It is suitable for the welding of fine thicknesses, namely less than 3 mm, and makes it possible to control the molten pool during position welding.

axial spray. For high welding energies, that is to say of at least 28 V for 280 A, and above a certain current density, typically greater than 250 A/mm² depending on the nature of the wire and the shielding gas, the end of the filler wire takes on an elongated cone shape. The transfer of the molten metal from the wire to the weld pool takes place in the form of fine droplets of molten metal, the diameter of which is less than that of the wire and which are sprayed at high speed in the axis of the wire. The arc is 4 to 6 mm long. This metal transfer provides a stable arc and little spatter. It allows high penetrations, namely of at least 5 mm, and large volumes of deposited metal, that is to say at least 15 m/min of wire rate. It is suitable for the welding of parts which have thicknesses of the order of 5 mm and above. However, the volume and the fluidity of the pool mean that it is mainly used in downhand welding.
globular regime. For welding energies between those giving short-circuit transfer and axial spray transfer, that is to say typically between 22 V for 200 A and 28 V for 280 A, the drops of metal which form at the end of the filler wire have a slow growth. Since the intensity of the current is not sufficient to have a pinching effect which gives rise to the detachment, the drop becomes large, that is to say having a size greater than the diameter of the wire in question. The transfer takes place either by a short-circuit, when the drop touches the pool, or by detachment of the drop under the effect of gravity. The drop then follows a trajectory which is not always in the axis of the arc. This mode of transfer is unstable, makes it possible to obtain only low welding penetrations and generates much spatter of metallic droplets.

It is necessary to add, to these three main regimes, three transfer regimes which necessitate unconventional welding parameters, namely:
the forced short arc regime. The short-circuit transfer does not make it possible to weld at high current, whereas an increase of the welding intensity leads to a globular transfer generating considerable adherent spatter and an equally considerable finishing time. Forced short-circuit or forced short-arc transfer makes it possible, with an arc energy normally located in the globular range, to maintain a transfer by short-circuit. This regime makes it possible to increase the welding rates and generates only fine spatter limiting the finishing time. Forced short-circuiting is obtained with transistorized welding machines, the waveforms of which make it possible to maintain a regular short-circuit.
the pulsed regime. Originally, the pulsed regime was developed to overcome the drawbacks of the globular regime which, due to its unstable transfer mode and its spattering nature, did not make it possible to increase productivity under acceptable welding conditions. In pulsed regime, welding is carried out with a pulsed current, by choosing the pulsation parameters so that there is, for each of the pulses, a transfer of axial spray type with a single drop per pulse. The regime here is forced, that is to say that the form of the current is imposed by carefully choosing the pulsation parameters so that the result is conclusive. Typically, the pulsation frequencies range from 50 to 300 Hz depending on the wire feed rate. This requires generators, transistor generators for example, for which it is possible to impose the form of the current as a function of time.
transfer by rotating liquid vein (or RLV). At very high welding energies, that is to say around 40 V for 450 A, axial spray transfer is subjected to high electromagnetic forces. Under the effect of these forces, the liquid metal being transferred starts rotating, forming a rotating liquid vein. Giving a high productivity, this regime appears at intensities of the order of 500 A and voltages of 45 to 50 V. The rounded penetration shape is favorable to groove filling and enables good compactness.

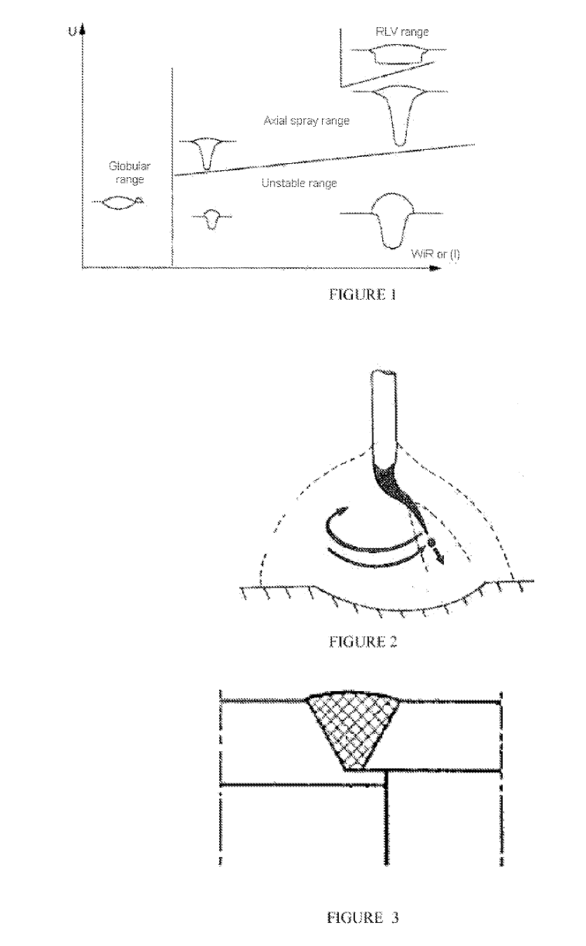

However, generally, the transfer depends on the wire rate and on the voltage. If the wire rate is high enough, the transfer changes from unstable to axial spray, then onto a rotating liquid vein, by increasing the voltage. The shape of the bead then results from the transfer applied. Thus, the morphologies of beads obtained with the various above-mentioned transfer modes are illustrated in FIG. 1.

As can be seen in FIG. 1, each transfer leads to a particular bead shape. Thus:
the globular regime is expressed by a lenticular penetration with presence of large adherent spatters.
the unstable regime is characterized by a curved, unwetted bead, with a slightly pointed penetration for low wire rates. The pointed shape becomes more pronounced with increasing wire rate.
the pulsed regime makes it possible to have bead morphologies of various types, owing to the large range of adjustments which its waveforms offer. At high wire rates, the obligation to greatly increase the frequency of the current pulses and also the peak intensity results in behavior very close to spray. This transfer is expressed at the bead by a geometry very close to that which smooth current spray transfer provides and a more pronounced penetration at the root of the bead.
the axial spray regime results in a thimble-shaped penetration which becomes more pronounced as the wire rate increases. The wetting is good.
the rotating liquid vein or RLV generates dish-shaped flat-bottomed bead penetrations.

Within the context of the present invention, the preferred transfer mode is the transfer of rotating liquid vein or RLV type.

In RLV transfer, for very high welding energies, that is to say of at least 40 V for 450 A, and under the effect of the electromagnetic forces present, the formation of a liquid vein which has a rotating movement is observed.

This RLV regime requires the use of a high voltage-current pair, i.e. greater than 40 V and 450 A, delivered by one (or more) power generators, the power envelope of which covers this energy range, given that commonly generators are found which do not deliver more than 400 A, and of a wire rate between 20 and 40 m/min as a function of the diameter of filler wire used, which wire must in addition always have a free terminal part of at least 25 mm. In order to do this, use is customarily made of a double-speed feeder, namely having speeds which can reach 50 m/min, which makes it possible, in a first regime at conventional wire rate, to ensure the smooth running of the startup and shutdown phases, and, in a second regime, to allow passage to the high deposition rate regime which requires high wire rates.

Furthermore, the welding nozzle delivering the wire and the gas shielding must be particularly well cooled by circulation of water.

Finally, the gas shielding applied during MIG/MAG welding in RLV regime is particularly important since it determines the obtaining of welding beads of more or less good quality, in particular when the parts are made of stainless steel.

### EXAMPLES

In view of this, the inventors of the present invention have sought to better understand the advantage and the influence of various gases participating in the gas mixture composition which is used for the shielding gas so as to attempt to improve the MIG/MAG welding process with transfer by rotating liquid vein at low energy level, that is to say less than 325 A and 40 V.

They were very particularly interested in helium, oxygen, CO₂ and argon, and carried out the comparative tests recorded below.

In fact, helium is used for its greater thermal conductivity. Indeed, it is possible to consider that, for any position along the axis between the wire and the part to be welded, a large part of the electrical energy provided by the source is contained in the enthalpy of the plasma, given that a portion of the shielding gas is ionized in order to form the electric arc, namely:

IV≈ρ_{A}h_{A}v_{A}A

where:
I is the welding current,
V is the potential difference between the electrode and the projection following the axis of the wire to the part to be welded,
ρ_{A} is the average density of the plasma,
v_{A} is the average velocity of the plasma, and
A is the surface area of the arc.

The energy flux density is then given by ρ_{A}h_{A}v_{A}, therefore one essential material characteristic of the plasma is the product ρh or ρcₚ since: cₚ=dh/dT.

According to the above equation, for the same values of I and V, an increase in the value of cₚ and therefore of the enthalpy h results in a reduced arc surface area A and therefore in a constricted arc.

A second effect is that the reduced surface area of the arc produces a higher current density and therefore larger magnetic forces.

It may also be noted that a higher velocity v_{A} produces a smaller value of A and a constricted arc. This effect is called the thermal pinch effect.

Furthermore, the role of the argon is itself to facilitate the ignition of the arc since it ionizes easily.

In addition, the oxygen and the CO₂ have a stabilizing effect on the arc but also for the surface-active aspect which will make it possible to obtain a liquid vein at the end of the consumable wire which will have a greater fluidity and which will be moved more easily by the magnetic forces.

Ultimately, the targeted objective was to succeed in obtaining, during the MIG/MAG welding of stainless steel, in particular with a joggled lap configuration (FIG. 3), an RLV transfer identical or similar to that shown diagrammatically in FIG. 2, at a low energy level.

In order to do this, tests were carried out on various ternary gas compositions, in particular ternary Ar/He/O₂ and Ar/He/CO₂ mixtures, as described in detail in the tests below.

### Test A (Comparative Test)

A first arc welding test on stainless steel was carried out in order to observe the behavior of the arc with an oxidizing gas mixture having the following composition (% by volume): 87% Ar+10% He+3% O₂.

The process employed is an automated MAG welding process with contribution of consumable wire with an Arcmate 120i robot from FANUC, a Digi@wave 500 generator, a feeder of DVR 500 type and a Promig 441 W torch from Air Liquide Welding.

The welding is carried out in full-sheet fashion on a part made of X2CrNi18 9 stainless steel having a thickness of 4 mm.

The composition of the wire acting as filler metal is of G 19 9L Si (ER 308L Si) stainless steel type and with a diameter of 1 mm.

The other welding parameters are as follows:
welding voltage: 31 V
intensity: 275 A
contact tip/part distance: 24 mm
gas flow rate: 25 l/min
welding rate (WeR): 160 cm/min
wire rate (WiR): 20 m/min
the axis of the torch forms an angle of approximately 45° with the surface of the part.

The results obtained with this oxidizing mixture (3% O₂) show that, while a rotating arc, that is to say a rotating liquid vein (RLV), is established, the arc height is far too high and results in significant spatter which adheres at the periphery of the weld pool. Furthermore, strong oxidation of the bead is observed.

The first mixture tested thus give results which are not acceptable industrially.

### Test B (Comparative Test)

Following the results obtained during test A, other welding tests on stainless steel were carried out with a second gas mixture comprising more helium, namely a gas mixture with the following composition: 77% Ar+20% He+3% O₂.

During test B, the parameters are overall the same as in test A, except for the adoption of the following parameters:
contact tip/part distance: 25 mm
WeR: 60 cm/min
welding voltage: 33.8 V
intensity: 278 A

The results obtained show, as above, a significant degree of spattering and strong oxidation of the bead. The RLV transfer is stable but the arc height is still too high. The bead exhibits a relatively good compactness but an excessively low penetration.

The use of an injection of a stream of inert gas (argon), that is to say an argon “drag rod”, behind the weld pool does not produce a significant difference.

The second mixture tested thus for its part also gives results which are not acceptable industrially, this being the case with or without an argon drag rod.

### Test C (Comparative Test)

Test C is analogous to test B, except for the use of slightly different welding parameters, namely:
welding voltage: 32.2 V
intensity: 249A
WiR: 18 m/min

The results obtained show, as above, a significant degree of spattering due to the centrifugal force exerted during the rotation of the arc and strong oxidation of the bead. The RLV transfer is not established and the arc is completely unstable.

### Test D (Invention)

The results of tests A to C confirm that the use of an oxygen-based gas mixture is not suitable for the welding of stainless steel.

In order to confirm that the highly oxidized appearance of the bead is caused by an excessively oxidizing nature of the gas mixtures tested (i.e., 3% by volume of O₂), other welding beads are produced while reducing the oxidizing power of the gas employed, in order to attempt to improve the surface appearance of the bead and to reduce the fluidity of the liquid vein.

In order to do this, the oxygen was replaced with carbon dioxide (CO₂). The gas tested then has the following composition: 81% Ar+18% He+1% CO₂.

The welding conditions are similar to those of the preceding tests (stainless steel wire, metal sheet, and the like) aside from the parameters employed which are given in the following table A.

TABLE A

| | | | WeR | | |
|---|---|---|---|---|---|
| WiR (m/min) | I (A) | U (V) | (cm/min) | CPD (mm) | Angle* (°) |
| 21.4 | 300 | 38.5 | 80 | 25 | 5 |

*Angle of inclination of the torch with respect to the vertical; in welding, reference is made to “5° push” position.

The beads obtained exhibit the following characteristics:
bead width: 15.3 mm
penetration: 1.9 mm
overthickness: 2.1 mm
total surface area: 42.1 mm²
penetrated surface area: 31.5 mm²
wetting angle: 155.3°

These results show that the gas tested is preferably compatible with the criteria desired for the use of RLV in the welding of stainless steels.

This is because the appearance of the bead is good, the degree of spatter is low and the surface oxidation has been considerably reduced.

### Test E (Invention)

In the light of the results of test D, supplementary tests were carried out under the same conditions as test D but with variable contents of CO₂.

The gases tested comprise from 0.5 to 3% of CO₂, 20% of helium and argon for the remainder, as given in the following table B.

TABLE B

| CO₂ content | WiR | U | I | WeR |
|---|---|---|---|---|
| (% by volume) | (m/min) | (V) | (A) | (cm/min) |
| 0.5 | 25 | 33.6 | 322 | 80 |
| 1 | 25 | 34.2 | 322 | 80 |
| 1.5 | 25 | 35.4 | 322 | 80 |
| 2 | 25 | 36.6 | 320 | 80 |
| 2.5 | 25 | 38.4 | 322 | 80 |
| 3 | 25 | 39 | 322 | 80 |

After examination of the macrographs obtained, it is found that, above 2% of CO₂, a spray regime appears, producing an unacceptable result.

The spatter (vicinity and on metal sheet) is very limited up to approximately 1.5% of CO₂ but becomes very great and completely unacceptable from 2.5% of CO₂.

The appearance of the bead gradually deteriorates with the increase in the CO₂ content. The best results are obtained for CO₂ contents of less than 1.5%, preferably of the order of 1%.

In all cases, the mixture which has given the best results is the mixture with the following composition: 20% He+1% CO₂+79% Ar, in particular on account of the excellent wetting resulting therefrom and of a much lower oxidation of the bead with respect to the same mixture but with oxygen in place of the CO₂.

It should be noted that these results have been validated during supplementary tests carried out on a joggled lap joint, namely two ferrules made of stainless steel welded to each other, as illustrated in FIG. 3.

In the end, these tests allow it to be concluded that a mixture formed of approximately 20% of helium, approximately 1% of CO₂ and argon for the remainder is perfectly suited to MAG welding with a rotating liquid vein, that is to say rotating arc MAG welding, of stainless steels, in particular lap joints, such as joggled lap joints and conventional lap joints.

The MIG/MAG welding process according to the invention is well suited to the welding of joggled lap joints, in particular water heater tanks, the bodies of extinguishers, vessels, and the like, of parts made of stainless steel but also to the fillet welding of any structure made of stainless steel based on thin girders, typically with a thickness of less than 5 mm, for example truck trailers which work only in fatigue and for which the root penetration depth is not the main criterion.

However, the gas mixture under consideration obviously allows efficient spray transfer. It thus makes it possible to be versatile if root penetration is desired.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. An electric arc welding process of MIG/MAG type with use of a consumable filler wire and gas shielding formed of a ternary gas mixture consisting of 19 to 21% of helium, of 0.8 to 1.2% of CO₂ and of argon for the remainder (% by volume) in order to weld one or more parts made of stainless steel, wherein the arc is a rotating arc, the consumable filler wire is melted by the arc, so as to obtain transfer of metal by a rotating liquid vein, and the welded parts comprise ends which overlap each other.

2. The process of claim 1, wherein the gas mixture comprises at least 19.5% of helium.

3. The process of claim 1, wherein the gas mixture comprises at most 20.5% of helium.

4. The process of claim 1, wherein the gas mixture comprises at least 0.9% of CO₂.

5. The process of claim 1, wherein the gas mixture comprises at most 1.10% of CO₂.

6. The process of claim 1, wherein the gas mixture comprises from 17.95 to 18.05% of helium, from 0.98 to 1.02% of CO₂ and argon for the remainder.

7. The process of claim 1, wherein the gas mixture is composed of 20% of helium, of 1% of CO₂ and of 79% of argon.

8. The process of claim 1, wherein the welded parts comprise cylindrical ends which overlap each other.

9. The process of claim 1, wherein the welded parts are constituent components of a pressure vessel of the following types: hot water tanks, extinguishers, compressors, refrigeration devices or gas cylinders.
